(19) United States
(12) Patent Application Publication
(10) Pub. No.: US 2026/0312640 A1
(43) Pub. Date: Oct. 8, 2026

(54) ULTRA-WIDEBAND RADIO-FREQUENCY BEAMFORMING APPARATUS

(71) Applicant: AMRF Technologies Inc., San Jose, CA (US)

(72) Inventor: Qianli MU, San Jose, CA (US)

(21) Appl. No.: 19/460,220

(22) Filed: Jan. 26, 2026

Related U.S. Application Data
(60) Provisional application No. 63/777,716, filed on Mar. 26, 2025.

(51) Int. Cl. H04B 7/06

(52) U.S. Cl. CPC H04B 7/0617

(57) ABSTRACT

Apparatuses, systems, and methods to transmit and receive beamformed radio-frequency (RF) signals. The circuits described herein can provide a controllable amount of phase delay to analog RF signals. By using two or more phase delaying circuits, RF signals can be steered or beamformed. In a similar manner, two or more phase delaying circuits can be used to receive beamformed RF signals and combine them.

### CLAIM OF PRIORITY

This patent application claims priority to U.S. provisional patent application no. 63/777,716, titled “ULTRA-WIDEBAND RADIO-FREQUENCY BEAMFORMING APPARATUS” and filed on Mar. 26, 2025, herein incorporated by reference in its entirety.

### GOVERNMENT SUPPORT

This invention was made with government support under a U.S. Small Business Innovation Research (SBIR) Phase 1 Award No. 2415054, awarded by the National Science Foundation (NSF). The government has certain rights in the invention.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

The systems and apparatuses described herein relate generally to beamforming radio-frequency (RF) signals, and more particularly to generating beamformed RF signals within the analog domain.

### BACKGROUND

Radio-frequency (RF) communication systems have become ubiquitous in modern society, enabling wireless connectivity between devices and facilitating the exchange of vast amounts of data. However, as the demand for wireless communication services continues to grow, the need for efficient and reliable RF communication systems has become increasingly pressing.

One of the primary challenges facing RF communication systems is the limited capacity of wireless channels. As the number of devices competing for access to these channels increases, the likelihood of interference and congestion also grows, leading to decreased data rates, increased latency, and reduced overall system performance.

RF Beamforming is a technique used to improve the efficiency and effectiveness of RF communication systems by directing the transmission and reception of RF signals towards specific targets or directions. By concentrating the energy of the RF signal in a particular direction, beamforming can increase the signal-to-noise ratio (SNR) and reduce interference, thereby enhancing the overall performance of the system.

Despite the potential benefits of beamforming, traditional beamforming techniques have several limitations. For example, they often require complex and computationally intensive algorithms, as well as complex digital circuits to implement. Conventional beamforming designs can take considerable design effort, sometimes requiring years to design, implement, and test. Furthermore, conventional beamforming techniques can be expensive.

### SUMMARY OF THE DISCLOSURE

Described herein are apparatuses, systems, and methods to transmit and receive beamformed radio-frequency (RF) signals that provide wideband and active phased arrays at different frequencies and applications. For example, described herein are radio-frequency signal processing (RFSP) apparatuses (e.g., devices, systems, etc.) for providing a variable pre-determined phase delay to a radio-frequency (RF) signal. These apparatuses may enable multi-function-capable and high performance wireless applications, including integration as part of a radio frequency front end (RFFE). In particular, these apparatuses may form at least part of an active phased array. Unlike traditional active phased arrays, which are expensive and require demanding signal conditioning beyond just signal amplification and filtering, the radio-frequency signal processing (RFSP) apparatuses described herein may be implemented as Configurable General-Purpose RF/Analog Processing Circuits that are capable of providing similar or wider bandwidth than “true” time delay based solution, and have a higher power efficiency and more compact size that traditional apparatuses. The apparatuses described herein may be implemented as wideband RF semiconductor apparatuses, including for use with 5G and satellite communications, integrated beamforming circuits (BMICs).

In some examples, a circuit can provide a controllable amount of phase delay to analog RF signals. By using two or more phase delaying circuits, RF signals can be steered or beamformed. In a similar manner, two or more phase delaying circuits can be used to receive beamformed RF signals and combine them.

Any of the apparatuses described herein may include a radio-frequency signal processing (RFSP) device for providing a variable predetermined phase delay to a radio-frequency (RF) signal. The RFSP device can include an RFSP input port, an RFSP output port, a plurality of gain control units (GCUs) coupled in parallel between the input port and the output port, wherein inputs of the GCUs are coupled to the input port of the RFSP and outputs of the GCUs are coupled to the output port of the RFSP, wherein each GCU, a first plurality of time delay units, each of the first plurality of the time delay units configured to couple an input of one of the plurality of GCUs to an input of another of the plurality GCU, a second plurality of time delay units, wherein each of the second plurality of time delay units configured to couple an output one of the plurality of GCUs to an output of another of the plurality of GCUs, where a phase delay of the RF signal through the RFSP device is based on gain settings of the plurality of GCUs.

Any of the RFSP devices can further include at least one phase inversion unit coupled between an input of one of the plurality of GCUs and the input port of the RFSP device and configured to invert the phase of an RF signal from the input port of the RFSP device to the input port of the GCU.

In any of the RFSP devices described herein each of the time delay units is a transmission line.

In any of the RFSP devices described herein each of the plurality of GCUs have an approximately equal propagation delay.

In any of the RFSP devices described herein a propagation delay associated with RF signals traveling from the RFSP input port, through a center GCU, and to the RFSP output port is a whole number of ½ wavelengths of the RF signal.

In any of the RFSP devices described herein the gain settings of the plurality of GCUs may be symmetric with respect to a center GCU.

Any of the apparatuses described herein may include radio-frequency (RF) beamforming apparatus. The apparatus including an input port configured to receive an input RF signal, a first output port, a second output port, a first radio-frequency signal processing (RFSP) device configured to output a first RF signal having a first phase delay based on gain settings of a first plurality of gain control units (GCUs) of the first RFSP device, a second RFSP device configured to output a second RF signal having a second phase delay based on gain settings of a

second plurality of GCUs of the second RFSP device, and a power divider configured to split and couple the input RF signal to an input of the first RFSP device and an input of the second RFSP device, where the first output port is configured to output the first RF signal and the second output port is configured to output the second RF signal and the first phase delay and the second phase delay are configured to beam steer the first RF signal and the second RF signal.

In any of the RF beamforming apparatuses described herein, the first output port is coupled to a first antenna and the second output port is coupled to a second antenna.

In any of the RF beamforming apparatuses described herein, the first RFSP device comprises at least one phase inversion unit coupled between an input of one of the first plurality of GCUs and the input port of the first RFSP device and configured to invert the phase of an RF signal from the input port of the first RFSP device to the input port of the GCU.

In any of the RF beamforming apparatuses described herein may include a first plurality of time delay units, each of the first plurality of the time delay units configured to couple an input of one of the first plurality of GCUs to an input of another of the first plurality GCUs and a second plurality of time delay units, wherein each of the second plurality of time delay units configured to couple an output one of the first plurality of GCUs to an output of another of the first plurality of GCUs.

In any of the RF beamforming apparatuses described herein, each of the time delay units are transmission lines.

In any of the RF beamforming apparatuses described herein, a propagation delay associated with RF signals traveling from an input for the first RFSP device, through a center GCU of the first RFSP device, and to an output of the first RFSP device is a whole number of ½ wavelengths of the input RF signal.

In any of the RF beamforming apparatuses described herein, each of the first plurality of GCUs have an approximately equal propagation delay.

In any of the RF beamforming apparatuses described herein can include a third RFSP device coupled in cascade after the first RFSP device and configured to receive the first RF output signal and output a third RF signal having a third phase delay based on gain settings of a third plurality of gain control units (GCUs) of the third RFSP device and a wide band amplifier configured to amplify the third RF signal from the third RFSP device.

For example, described herein are radio-frequency signal processing (RFSP) devices for providing a variable pre-determined phase delay to a radio-frequency (RF) signal, the RFSP device comprising: an RFSP input port; an RFSP output port; a plurality of gain control units (GCUs), comprising an odd number of GCUs, coupled in parallel between the input port and the output port, wherein inputs of the GCUs are coupled to the input port of the RFSP and outputs of the GCUs are coupled to the output port of the RFSP, wherein each GCU; a first plurality of time delay units, wherein each of the first plurality of the time delay units is configured to couple an input of one GCU of the plurality of GCUs to an input of another GCU of the plurality GCU; and a second plurality of time delay units, wherein each of the second plurality of time delay units is configured to couple an output one GCU of the plurality of GCUs to an output of another GCU of the plurality of GCUs, wherein a phase delay of the RF signal through the RFSP device is based on gain settings of the plurality of GCUs.

Any of these RFSP devices may include at least one phase inversion unit coupled between an input of one of the plurality of GCUs and the input port of the RFSP device and configured to invert the phase of an RF signal from the input port of the RFSP device to the input port of the GCU. For example, the at least one phase inversion unit may comprise (n-1)/2 phase inversion units, where n is the number of GCUs.

Each of the time delay units may be a transmission line. In some cases, each of the plurality of GCUs may have an approximately equal propagation delay. The gain settings of the plurality of GCUs may be symmetric with respect to a center GCU. The RFSP device may comprise an integrated chip including the plurality of CGUs.

For example, a radio-frequency (RF) beamforming apparatus may include: an input port configured to receive an input RF signal; a first output port; a second output port; a first radio-frequency signal processing (RFSP) device configured to output a first RF signal having a first phase delay based on gain settings of a first plurality of gain control units (GCUs) of the first RFSP device; a second RFSP device configured to output a second RF signal having a second phase delay based on gain settings of a second plurality of GCUs of the second RFSP device; and a power divider configured to split and couple the input RF signal to an input of the first RFSP device and an input of the second RFSP device, wherein the first output port is configured to output the first RF signal and the second output port is configured to output the second RF signal and the first phase delay and the second phase delay are configured to beam steer the first RF signal and the second RF signal.

The first output port may be coupled to a first antenna and the second output port is coupled to a second antenna. Any of these RF beamforming apparatuses may include one or more amplifiers coupled to the first and/or second output ports. The first RFSP device may comprise at least one phase inversion unit coupled between an input of one of the first plurality of GCUs and the input port of the first RFSP device and configured to invert the phase of an RF signal from the input port of the first RFSP device to the input port of the GCU.

The first RFSP device may include: a first plurality of time delay units, each of the first plurality of the time delay units configured to couple an input of one of the first plurality of GCUs to an input of another of the first plurality GCUs; and a second plurality of time delay units, wherein each of the second plurality of time delay units configured to couple an output one of the first plurality of GCUs to an output of another of the first plurality of GCUs.

As mentioned, each of the time delay units may be transmission lines. In some cases each of the first plurality of GCUs may have an approximately equal propagation delay. Any of these RF beamforming apparatuses may include: a third RFSP device coupled in cascade after the first RFSP device and configured to receive the first RF output signal and output a third RF signal having a third phase delay based on gain settings of a third plurality of gain control units (GCUs) of the third RFSP device; and a wide band amplifier configured to amplify the third RF signal from the third RFSP device.

A beamforming circuit may include: a plurality of radio-frequency signal processing (RFSP) devices arranged in parallel, wherein the plurality of RFSPs comprises a plurality of any of the RFSPs of claims 1-7; and a power divider network coupled to the plurality of RFSP devices.

The beamforming circuit may be configured as a transmitter in which one or more outputs of the power divider network are coupled to the inputs of the plurality of RFSPs. The beamforming circuit may be configured as a receiver in which one or more inputs of the power divider network are coupled to the outputs of the plurality of RFSPs.

A beamforming circuit may include: a plurality of sub-modules, wherein each sub-module comprises: a plurality of radio-frequency signal processing (RFSP) devices arranged in parallel, wherein the RFSPs of the plurality of RFSPs comprise any of the RFSPs of claims 1-7; one or more switches; and a power divider coupled to the plurality of RFSP devices through the one or more switches.

Each RFSP device of the plurality of RFSP devices may comprise an additional RFSP device connected in series. The plurality of sub-modules may comprise a first sub-module connected to a second sub-module so that the input of the second sub-module comprises the output of the first sub-module.

Also described herein are methods of manufacturing a radio-frequency signal processing (RFSP) device, the method comprising: forming an integrated circuit (IC) including an RFSP device, the RFSP device including: an input port, an RFSP output port, a plurality of gain control units (GCUs) coupled in parallel between the input port and the output port, wherein inputs of the GCUs are coupled to the input port of the RFSP and outputs of the GCUs are coupled to the output port of the RFSP, wherein each GCU, a first plurality of time delay units, wherein each of the first plurality of the time delay units is configured to couple an input of one GCU of the plurality of GCUs to an input of another GCU of the plurality GCU, and a second plurality of time delay units, wherein each of the second plurality of time delay units is configured to couple an output one GCU of the plurality of GCUs to an output of another GCU of the plurality of GCUs, wherein a phase delay of the RF signal through the RFSP device is based on gain settings of the plurality of GCUs.

Forming the integrated circuit may comprise forming the RFSP as a monolithic microwave integrated circuit (MMIC). Forming the integrated circuit may comprise forming using a semiconductor processes selected from one or more of: an GaAs process, an RF-CMOS, and/or a GaNSi process. Forming the integrated circuit may comprise forming the RFSP as an IC with a multi-layer PCB.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 shows an example of a communication system configured to implement radio-frequency (RF) beamforming.

FIGS. 2A and 2B illustrate examples of RFSP apparatuses configured to provide a variable pre-determined phase delay as described herein. FIG. 2A shows an example of a 5-tap implementation of an RFSP unit and FIG. 2B shows an example of a 7-tap implementation of an RFSP unit.

FIG. 3A is a block diagram of an example radio-frequency signal processing (RFSP) apparatus configured to provide a variable pre-determined phase delay to a radio-frequency (RF) signal as described herein. FIGS. 3B and 3C shows examples of block diagrams of RFSP units similar to that shown in FIGS. 3A. FIG. 3B is a four-post device. FIG. 3C terminates in two adjacent ports with load impedance matched similar (but opposite) to that shown in FIG. 3A.

FIGS. 3D and 3E show graphs of the frequency response of the RFSP shown in FIG. 3A and 3C, respectively.

FIGS. 4A and 4B show examples of beamforming integrated circuits (BMICs) including an RFSP apparatus configured to provide a variable pre-determined phase delay to a radio-frequency (RF) signal as described herein, which may be used as part of an RF front end such as that shown in FIG. 1.

FIG. 5 shows a system that includes a first RFSP and a second RFSP.

FIG. 6 shows phase response graphs of the RFSPs of FIG. 5.

FIG. 7 is a graph showing gain unit/delta phase relationships for the RFSPs of FIG. 5.

FIG. 8 is a graph showing a delta phase relationship of the first RFSP and the second RFSP of FIG. 5.

FIG. 9 shows a graph of example gains of the first RFSP and the second RFSP over frequency ranges from 1 GHz to 9 GHz.

FIG. 10 shows a graph showing example frequency response of RFSPs.

FIG. 11A shows a circuit diagram of an example phase inversion unit (PIU).

FIG. 11B shows a circuit of an example gain control unit (GCU).

FIG. 12 shows example responses of GCUs included in a five tap RFSP, where the GCUs are implemented using a gallium arsenide (GaAs) pseudomorphic high electron mobility transistor (pHEMT) process.

FIG. 13 shows an example implementation of a BMIC configured for transmitting RF signals.

FIG. 14 shows an example implementation of a BMIC configured for receiving RF signals.

FIG. 15 shows an example implementation of a BMIC that can perform operations of a transceiver.

FIG. 16 shows another example BMIC that can perform operations of a transceiver.

### DETAILED DESCRIPTION

Described herein are radio-frequency signal processing (RFSP) apparatuses (e.g., devices, units, systems, etc.) that provide a variable pre-determined phase delay as well as methods of making and using them. Also described herein are ultra-wideband Beamforming Integrated Circuits (BMICs), including any of these RFSPs described herein. These methods and apparatuses may be implemented as Configurable General-Purpose RF/Analog Processing Circuits. In general, these methods and apparatuses are configured as active devices, which not only enable the circuit to achieve a comparable or even wider bandwidth than traditional passive time-delay-based solutions, but also provide significant advantages in terms of power efficiency and size. For example, traditional time-delay systems typically require bulky components and significant power consumption to achieve wideband performance, while the active RFSP apparatuses described herein may meet demanding power budgets, all while maintaining a more compact form factor. This is a major benefit for systems that need to balance high performance with constrained power and space limitations.

Advantageously, these methods and apparatuses may provide a universal, standard solution for wideband applications, particularly in the context of active phased arrays. Active phased arrays are crucial in many modern radar, communication, and sensing systems, where the ability to dynamically steer beams and operate over a broad frequency range is essential. Traditionally, these systems have been constrained by specific frequency ranges or complex, custom-built designs. However, this invention overcomes these limitations by providing a flexible and adaptable wideband solution that can be deployed across a wide array of frequencies and applications. As a result, the techniques described herein can substantially reduce both development time and costs, as a single, standardized design can be used across different platforms and use cases, eliminating the need for bespoke solutions for each application.

Furthermore, the wideband capability of this invention, coupled with its efficient implementation methodology, offers a clear pathway for long-term cost reduction in terms of the overall system components. The RFSP apparatuses described herein may also allow the optimization of manufacturing processes, which can be tailored to semiconductor fabrication techniques capable of meeting the stringent performance requirements while simultaneously reducing the cost per unit area, which may provide economies of scale and advanced fabrication techniques, and enable a reduction in component costs as demand for these components increases.

The RFSP apparatuses described herein provide a multi-functional, wideband solution for a range of applications, which may drive significant cost efficiencies through increased production volumes and streamlined manufacturing. By consolidating various functionalities into a single integrated circuit that can be deployed across multiple applications, this approach not only reduces the cost of individual components but also accelerates the adoption of advanced wideband technologies in a variety of fields, such as telecommunications, defense, aerospace, and scientific research.

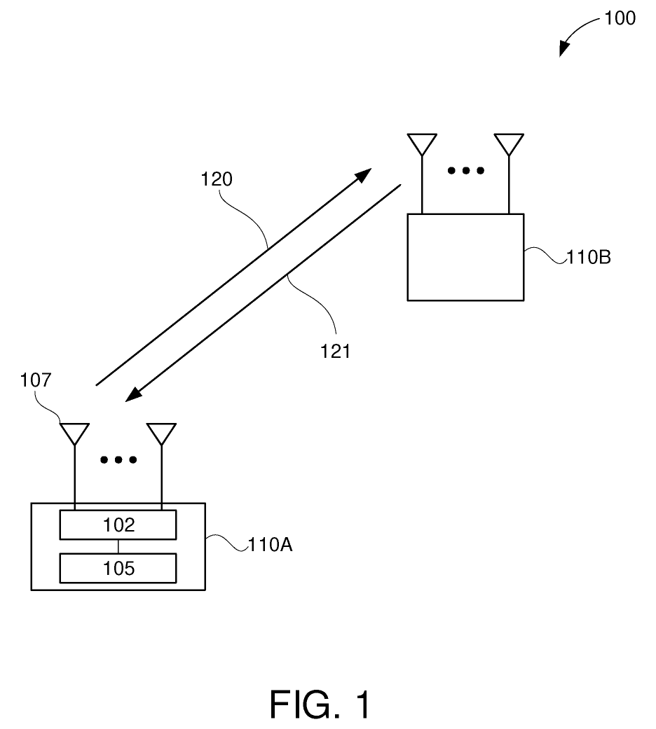

As mentioned, the RFSP apparatuses described herein may be part of a radio frequency front end (RFFE). In particular, these apparatuses may form at least part of an active phased array. For example, FIG. 1 shows a communication system 100 configured to implement radio-frequency (RF) beamforming. As shown, the communication system 100 includes a first station 110A and a second station 100B. Although only two stations are illustrated here for simplicity, the communication system 100 can include any feasible number of stations. The first station 110A can include an RF front end 102 and a controller 105. The second station 110B can be similarly configured.

The controller 105 may provide the RF front end 102 data to transmit to station 110B. In addition, the controller 105 can determine beamforming directions to transmit data to station 110B. In some examples, the controller can send a sounding packet through the RF front end 102 to the station 110B. Upon receiving the sounding packet, the station 110B can respond with a return packet to the station 110A. Analyzing the sounding packet and the return packet, the controller 105 can determine how to transmit beamformed RF signals 120 to the second station 110B. In some examples, the second station 110B can use information from the sounding packet to determine how to transmit beamformed RF signals 121 to the first station 110A.

The RF front end 102 is coupled to the controller 105 and two or more antennas 107. The RF front end 102 can include analog circuits, modules, or integrated circuits that enable the transmission of beamformed RF signals as well as the reception of beamformed RF signals. In particular, an RF front such as (but not limited to) the RF front end in the system shown schematically in FIG. 1, may include any of the RFSP apparatuses described herein.

An RFSP apparatuses providing a variable pre-determined phase delay to a radio-frequency (RF) signal may be referred to herein as an RFSP unit, or simply an RFSP.

In general, any of these RFSP units may include a first phase network (e.g., a phase network with a termination input, PNI), a gain control unit (CGU), a phase inversion unit (PIU), and a second phase network (e.g., a phase network with a termination output, PNO). The gain control unit includes a plurality of amplifies acting act taps into the phase network. In general, an odd number of taps is used, with a central tap flanked by taps connected to the PNI through individual phase inversion units (PIUs) on one side of the central tap, and the central tap and taps on the other side connected to the PNI without connecting to phase inversion units; these taps may be connected to non-inverting (buffer) units.

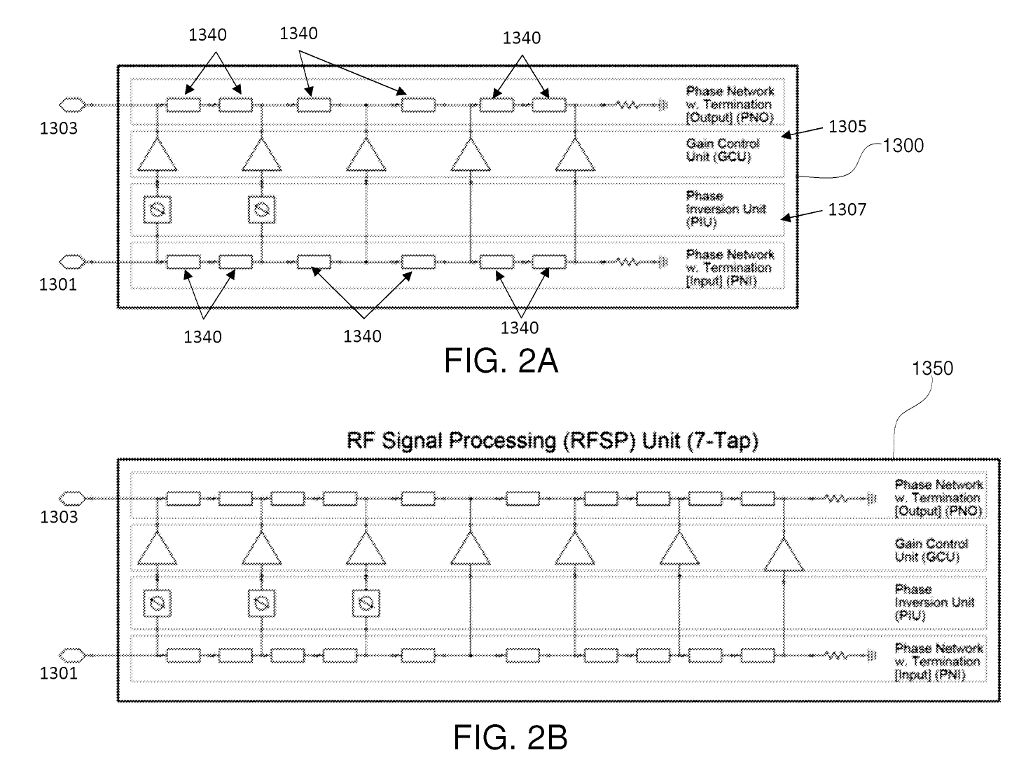

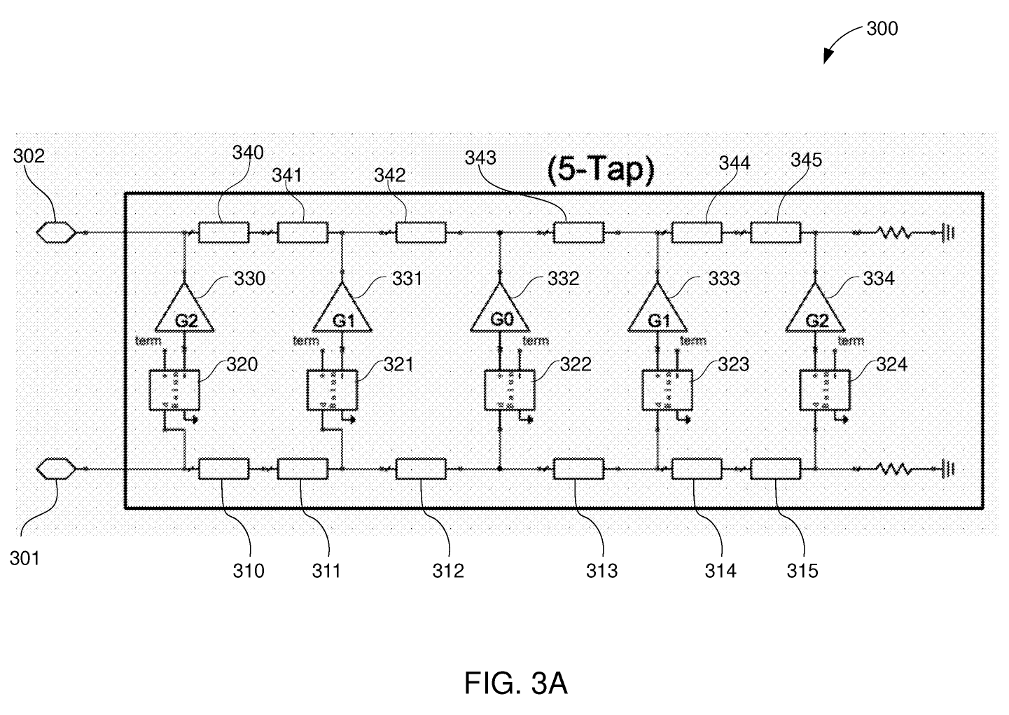

FIG. 2A shows an example of a 5-tap RFSP unit 1300, and FIG. 2B shows an example of a 7-tap implementation of an RFSP unit 1350. In FIGS. 2A the 5-tap RFSP 1300 similar to the RFSP 300 of FIG. 3A, below. As mentioned, FIGS. 2A-2B do not show non-inverting units (corresponding to the PIUs shown) for simplicity. The 7-tap RFSP shown in FIG. 2B is similar to the 5-tap RFSP 1300 shown in FIG. 2A. As in any of the RFSPs described herein having n taps, (n-1)/2 of these taps may be connected to a phase inversion unit (PIU), while the rest of the taps may be connected to a buffer. The phase inversion units are arranged symmetrically on either side of the central tap. In general, the number of taps, n, should be an odd number.

In FIGS. 2A-2B the RFSP includes an input port 1301 and an output port 1303. The input port connects to the PNI, and each gain control unit (GCU) of the plurality of gain GCUs 1305 connects to the input port 1301 through the PNI. Similarly, each CGU of the plurality of GCUs are connected to the same output 1303 through the PNO. Thus, the GCUs are coupled in parallel between the input port and the output port by connecting to the phase network input (PNI) and the phase network output (PNO).

Either or both the PNI and/or PNO may be configured to include a time delay unit (or more than one time delay units) 1340 between the connections to each CGU. These time delay units may be configured as baluns, which act as a transformer to interface between balanced and unbalanced transmission lines without disrupting the impedance of either line. This, the RFSP unit may include a first plurality of time delay units on the PNI (input line). Time delay units of the first plurality of the time delay units may be configured to couple between adjacent CGUs such that an input of one GCU of the plurality of GCUs is connected in parallel to an input of another GCU of the plurality GCU with one or more time delay units between them. Similarly, each time delay unit of the second plurality of time delay units may be coupled between adjacent CGUs so that an output of one GCU of the plurality of CGUs is connected in parallel to an output of another CGU.

As discussed above and shown in FIGS. 2A-2B, one less than half of the GCUs (on one side of the RFSP circuit, e.g., to the left or right of the center tap) are also coupled to a phase inversion unit 1307 between the GCU and the PNI.

In general, the GCUs may be configured so that the phase delay of the RF signal through the RFSP device is based on gain settings of the plurality of GCUs.

FIG. 3A is a block diagram of another example of an RFSP unit 300. The example RFSP unit 300 includes five taps or legs. RFSP units can have different numbers of taps such as three taps, seven taps or the like. Generally, RFSP units will include odd numbers of taps, but even numbers of taps are possible.

In general, the RFSP unit may be implemented as a four-port device (see, e.g., FIG. 3B) and reduced to a two-port device (see FIGS. 3A and 3C) by terminating two adjacent ports with load impedance matched with the transmission line characteristic impedance, for example 50 ohm. This is illustrated in the 5 tap RFSP examples shown in FIGS. 3A and 3C. This configuration leads to two different ways to terminate an RFSP unit, and there is a natural 180-degree difference between the two cases, which is due to the center tap (g0) phase delay in respect to the tap closest to the input/output ports. Each transmission segment in the schematic shown in FIGS. 3A-3C represents the same time delay unit and when its electrical length is equal to 90 degrees, that is the cutoff frequency of RFSP. An RFSP unit may lose its phase tuning capability with respect to GCU settings. For example, as illustrated in FIGS. 3D and 3D, at the cutoff frequency, the phase delay through RFSP may become a constant. In the examples shown in FIGS. 3D-3E the RFSP unit may be configured so that each transmission line is a quarter-wavelength transmission at 20GHz, and the delta-phase response of two RFSPs. For example, FIG. 3D shows a graph illustrating when the two RFSPs are terminated in the same way (FIG. 3A) and FIG. 3E shows a graph illustrating when the two RFSPs are terminated in opposite ways (see FIG. 3C).

The RFSP unit 300 includes an input port 301, an output port 302, delay elements 310, 311, 312, 312, 313, 314, 315, and 340, 341, 342, 343, 344, and 345, phase inversion units (PIU) 320, 321, 322, 323,and 324 and gain control units (GCU) 330, 331, 332, 333, and 334. Each tap can include one GCU and one PIU. For example, a first tap can include GCU 330 and PIU 320, a second tap can include GCU 331 and PIU 321, and so on. Each tap is separated from an adjacent tap by a number of delay elements. In general, each delay element represents approximately the same amount of phase delay at the same frequency, or the same physical length, if traditional transmission line is used. The delay elements may be 90 degrees at the high-end cutoff frequency. In the example of FIG. 3A, each delay element 310-315 and 340-345 can have a phase delay. In some examples the phase delay, particularly at the may be, e.g., about ¼ λ, where λ is the wavelength of the RF signal of interest. Thus, delay elements 310, 311, 340, and 341 can separate the second tap (GCU 331 and PIU 321) from the input port 301 and the output port 302 by ½ λ or 180 degrees. Although shown as separate delay elements 310-315 and 340-345, actual implementation of the delay elements may be simplified by combining some delay elements. For example, the ¼ λ delay elements 310 and 311 can be combined into a single ½ λ delay element.

Notably, the delay elements can be arranged symmetrically about a center tap of the RFSP 300. For example, the tap including the GCU 332 can be the center tap of the RFSP 300. Delay elements that separate the center tap from the other taps can be equally distributed and symmetric. The GCUs 330-334 may be wide-band variable gain amplifiers. In general, the GCUs 330-334 are selected to have a working bandwidth of at least a wide as the desired bandwidth of the RFSP unit 300. Each GCU 330-334 can have an independently controlled gain. Notably, the gain setting of any one GCU unit may be shared with at least one other GCU unit. For example, the gain setting of GCU 330 is shared with (has the same setting as) the GCU 334. This common gain setting is illustrated in FIG. 3A with“G2”. Similarly, the gain setting of GCU 331 is the same as the gain setting for GCU 333, “G1”. Notably, the gain setting of the middle tap (GCU 332) “G0” is not shared with any other GCU. In this manner, the gain settings of the GCUs are symmetric with respect to the center tap (a center GCU). Inputs of each GCU are coupled (through PIUs and delay elements) to the input port of the RFSP. Similarly, outputs of each GCU are coupled through delay elements to the output port of the RFSP.

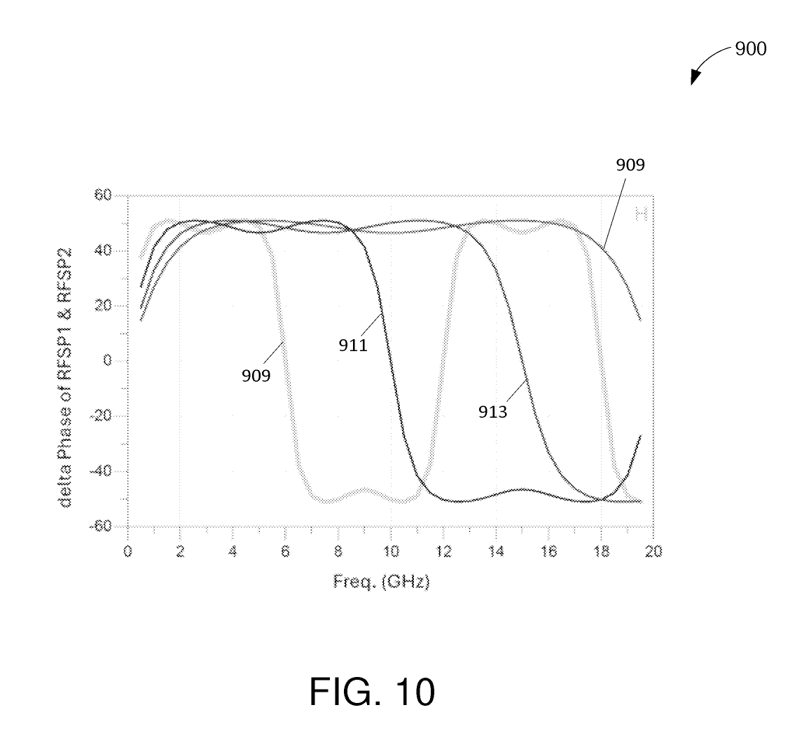

The PIUs 320-324 can either invert the phase of an input RF signal or buffer the input RF signal. In the example RFSP unit 300, the PIUs 320 and 321 can invert the phase of an input RF signal and the PIUs 322-324 can simply buffer an input RF signal. PIU designs are discussed in more FIGS. 3 and 11A.

In some examples, controlling the gain of the GCUs 330-334 and operation of the PIUs 320-324 can control operation and/or performance of the RFSP 300. Performance of the PIUs are described in more detail in conjunction with FIG. 11A.

As discussed above, any of the RFSPs described herein may be used with or included as part of any apparatus, including in particular with an RFSP based beamforming apparatus. For example, such an apparatus may include a plurality of (e.g., more than one) RFSPs cascaded to allow more than +/-90 degree phase difference between two channels, with 2 RFSP cascaded being the most common case. In some cases these RFSPs may be configured as part of an extended beamforming system, which may include a module that is created by integrating 2 channels, where each channel has two RFSPs cascaded, with a power splitter/combiner in a single package device. Such a module may allow for the creation of beamforming networks using a corporate network, e.g. 1 to 2, then 2 to 4, and so forth.

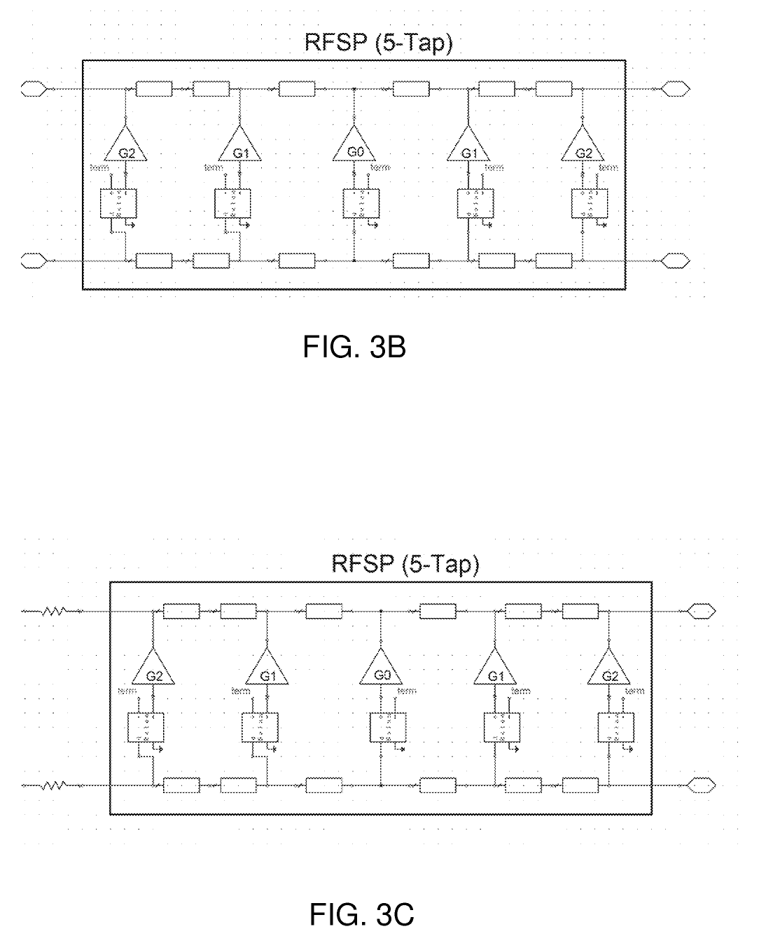

FIGS. 4A and 4B show example beamforming integrated circuits (BMICs) that may be used in the RF front end 102 of FIG. 1. Although described here as an integrated circuit, as used herein, a BMIC can be any RF beamforming apparatus or device. FIG. 4A shows a BMIC 200 configured to transmit beamformed RF signals. The BMIC 200 includes four RF signal processing (RFSP) units 201, 202, 203, and 204 and three power dividers 210, 211, and 212. Each RFSP unit 201-204 can introduce an independent, controllable (pre-determined) phase and/or gain change to an RF signal. Each RFSP unit 201-204 can be an ultra-wide band unit, meaning that the RFSP units 201-204 can process RF signals from at least one to ten GHz. An RF signal to be transmitted is received at input port 220. The RF signal is split through the power dividers 210-212 and then coupled to the RFSP units 201-204. Each of the RFSP units 201-204 can have outputs 230, 231, 232, and 233 that can be coupled to individual antennas (not shown). Since each RFSP unit 201-204 can provide independent, controllable phase and/or gain changes to the input RF signal, the BMIC 200 can be configured to output a beamformed RF signal from the outputs 230-233.

The BMIC 200 can be an ultra-wideband BMIC based on the concept of ‘Configurable General-Purpose RF/Analog Processing Circuit’. Because of its active device based nature, not only is it capable of providing similar or wider bandwidth than true time delay based solution, but also able to meet system’s power budget requirement with higher power efficiency and more compact size.

Any BMIC described herein can advantageously provide a wideband solution for active phased arrays at different frequencies and applications, which drives down development time and cost. In addition, because of its wideband capability and the implementation method, it provides a clear path to drive down the component BOM cost over time through consolidating application opportunities and manufacturing with semiconductor processes able to meet the performance requirement and have lower cost per unit area.

FIG. 4B shows a BMIC 250 configured to receive beamformed RF signals. The BMIC 250 includes four RFSP units 251, 252, 253, and 254 and three power dividers 260, 261, and 262. Each RFSP unit 251-254 can introduce an independent, controllable phase and/or gain change to input RF signals. The input RF signal may be received through antennas (not shown) at input ports 280, 281, 282, and 283. From the input ports 280-283, the received RF signal is received by a corresponding RFSP unit 251-254. Similar to the RFSP units 201-204 in the BMIC 200, the RFSP units 251-254 can provide an independent and controllable phase and/or gain change to an RF signal. The outputs of the RFSP 251-254 can be combined through the power combiners 260-262 and output through an output port 270. In this manner, the BMIC 250 can receive beamformed signals transmitted from other sources.

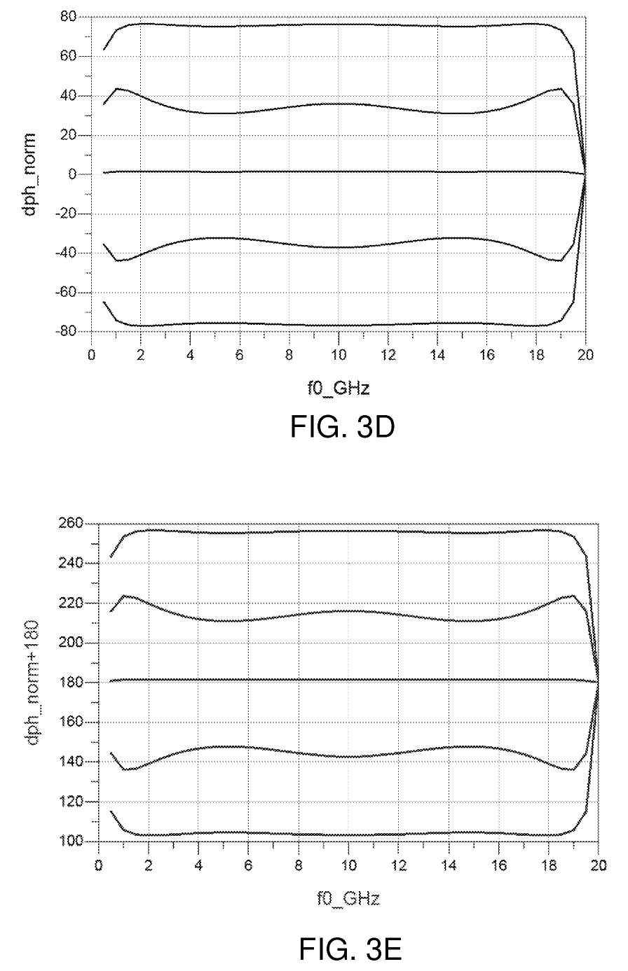

To illustrate the phase shifting properties of the RFSP units, FIG. 5 shows a system 400 that includes a first RFSP 410 and a second RFSP 420. In this example, both the first RFSP 410 and the second RFSP 420 are identical 5-tap devices similar to the RFSP 300 of FIG. 3A. As shown, each tap includes a GCU and a PIU. For simplicity, the PIUs which function solely as buffers are not drawn in the appropriate taps, thus PIUs are only shown on first and second taps of the first RFSP 410 and the second RFSP 420. Furthermore, each tap is separated from adjacent taps by one or more delay elements as described in the RFSP unit 300.

In some examples, operation of each of the RFSP devices is controlled through gain settings of the GCUs within each respective RFSP. In other words, controlling the amount of gain that is provided by each of the GCUs within an RFSP controls how much phase delay is provided by the RFSP. Returning to the transmitting BMIC 200 example of FIG. 4A, the first RFSP 410 can be used to implement the RFSP 201 and the second RFSP 420 can be used to implement the RFSP 202.

The first RFSP 410 can include an input port 411 and an output port 412. Similarly, the second RFSP 420 can include an input port 421 and an output port 422. Returning again to the BMIC 200, the input ports 411 and 412 may be coupled to a power divider (not shown in FIG. 5). In this manner an identical RF signal can be provided to both the first RFSP 410 and the second RFSP 420. Thus, the output port 230 can output a first phase shifted version of an RF signal received at input port 220 and the output port 231 can output a second phase shifted version of the RF signal received at the input port 220. Each RFSP can be independently controlled to provide different amount phase delay (phase shift).

In some examples, the first RFSP 410 and the second RFSP 420 can be implemented as a single integrated circuit using semiconductor processes, such as GaAs pHEMT, Si RF-SOI, SiGe BiCMOS or the like. Any RFSP can also be implemented as a packaged module, like LGA, with multiple chips and passives on laminate. Using RFSPs as the building block, BMICs can be implemented as a packaged module.

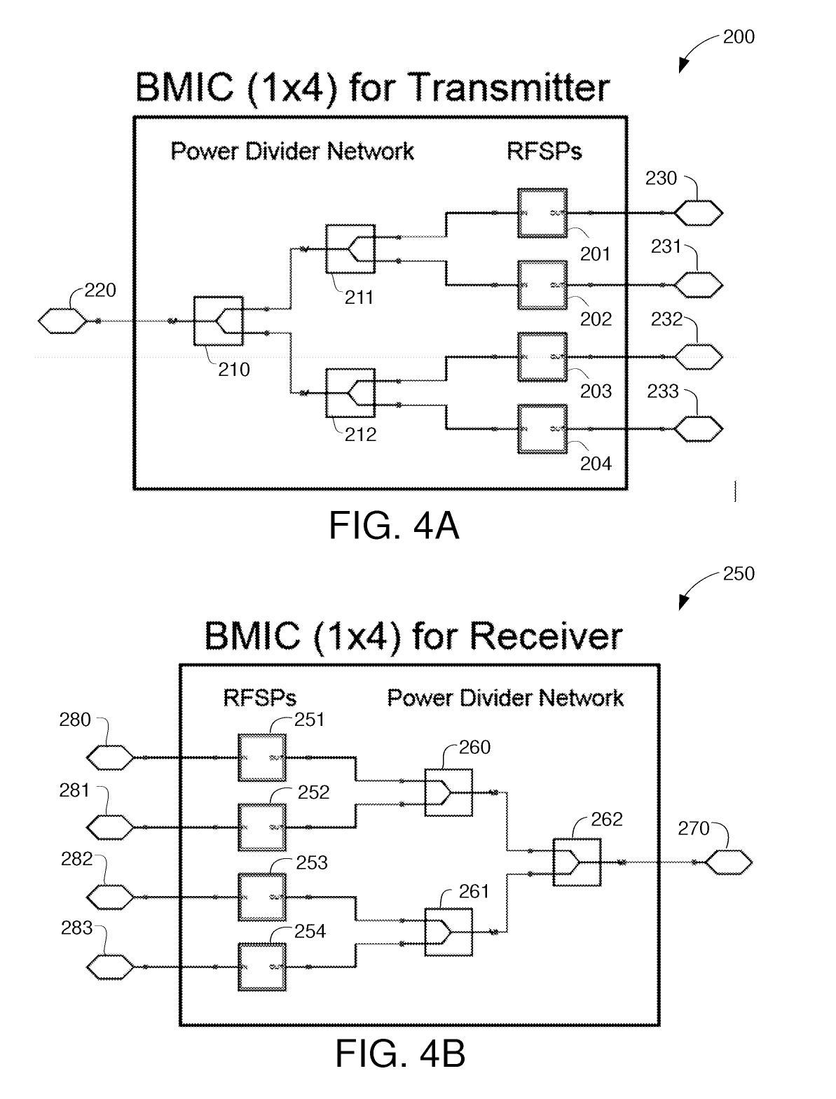

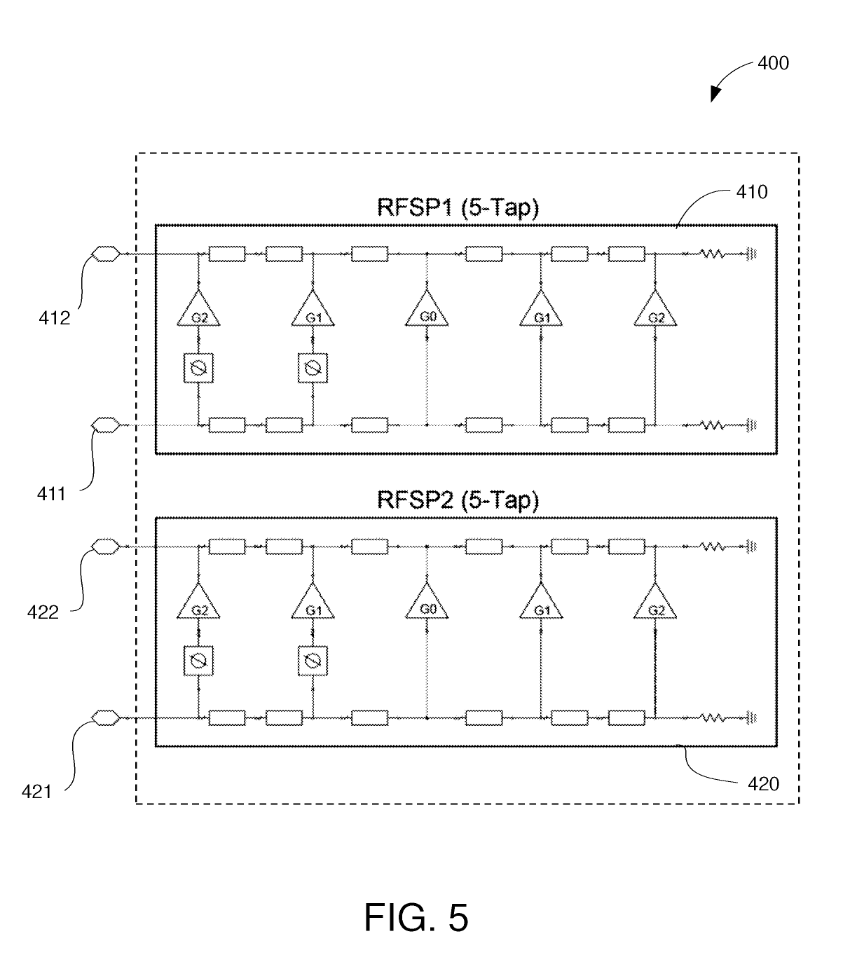

FIG. 6 shows phase response graphs 500 of the RFSPs of FIG. 5. Graph 510 may be associated with performance of the first RFSP 410 and graph 520 may be associated with performance of the second RFSP 420. As shown, the phase response of the first RFSP 410 and the second RFSP 420 can be approximately linear. Recall that each RFSP 410 and RFSP 420 may be “tuned” individually by adjusting the gains of the GCUs of each RFSP. FIG. 7 is a graph 600 showing GCU/delta phase relationships for the first RFSP 410 and the second RFSP 420. Thus, by setting GCUs to have a particular gain, a particular phase delay can be obtained.

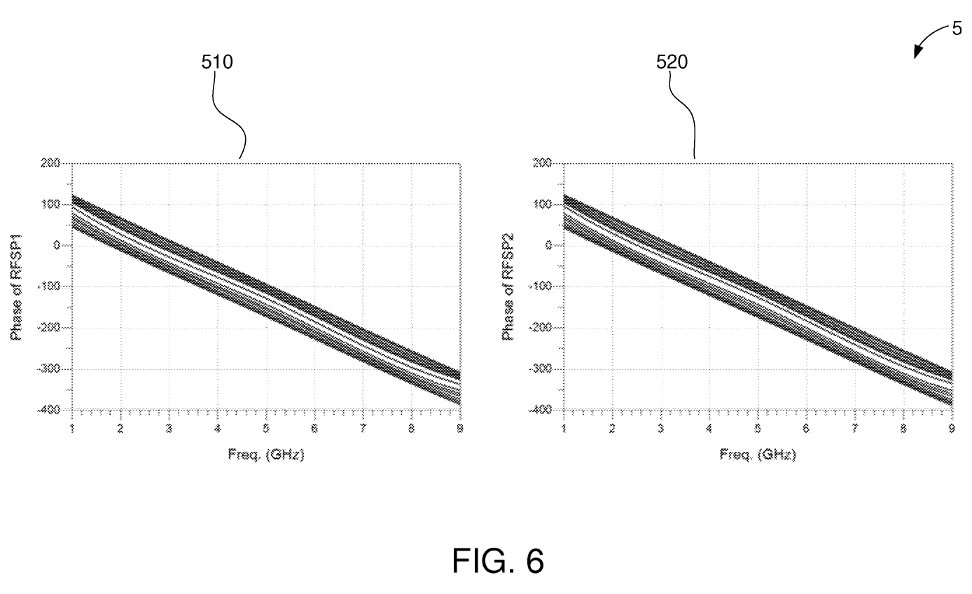

FIG. 8 is a graph 700 showing a delta phase relationship of the first RFSP 410 and the second RFSP 420 of FIG. 5. Notably, the delta phase for both the first RFSF 410 and the second RFSP 420 are relatively flat between 1 and 9 GHz. This flat delta phase response means that a stable phase delay can be realized for the first RFSP 410 and the second RFSP 420 through a bandwidth of approximately 8 GHz. The flat delta phase response can be advantageous for steering beamformed signals. Note that the frequency range shown in the graph of FIG. 8 is just one example, which is based on the selected delay unit physical length shown as 310 to 315 and 340 to 345 in FIG. 3A.

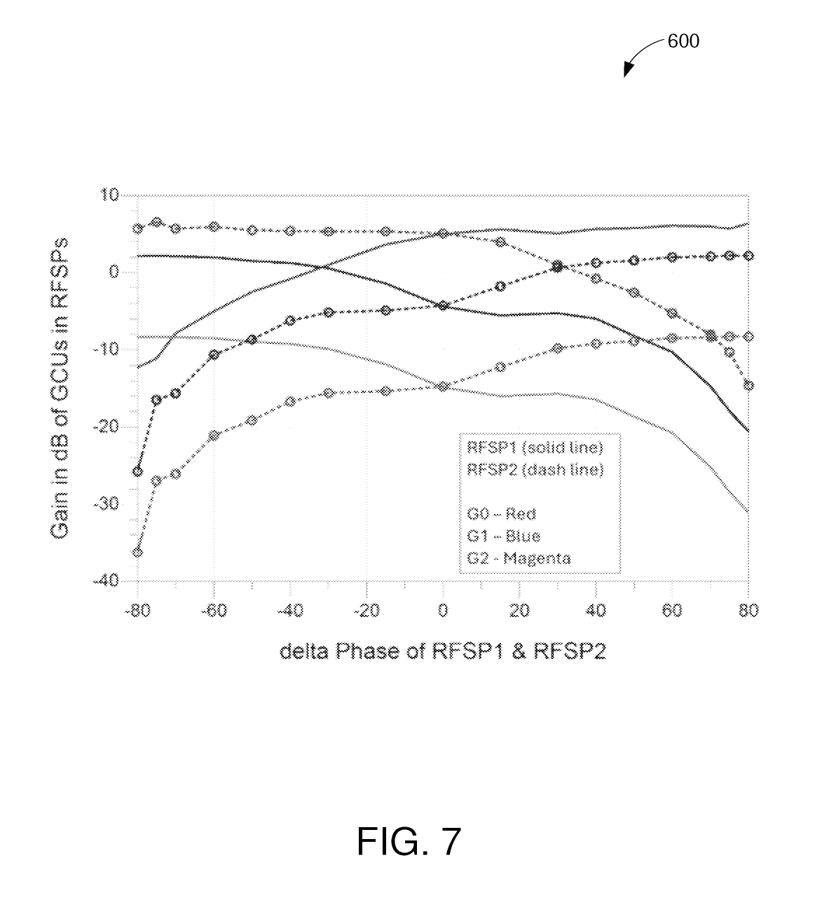

FIG. 9 shows a graph 800 of example gains of the first RFSP 410 and the second RFSP 420 over frequency ranges from 1 GHz to 9 GHz.

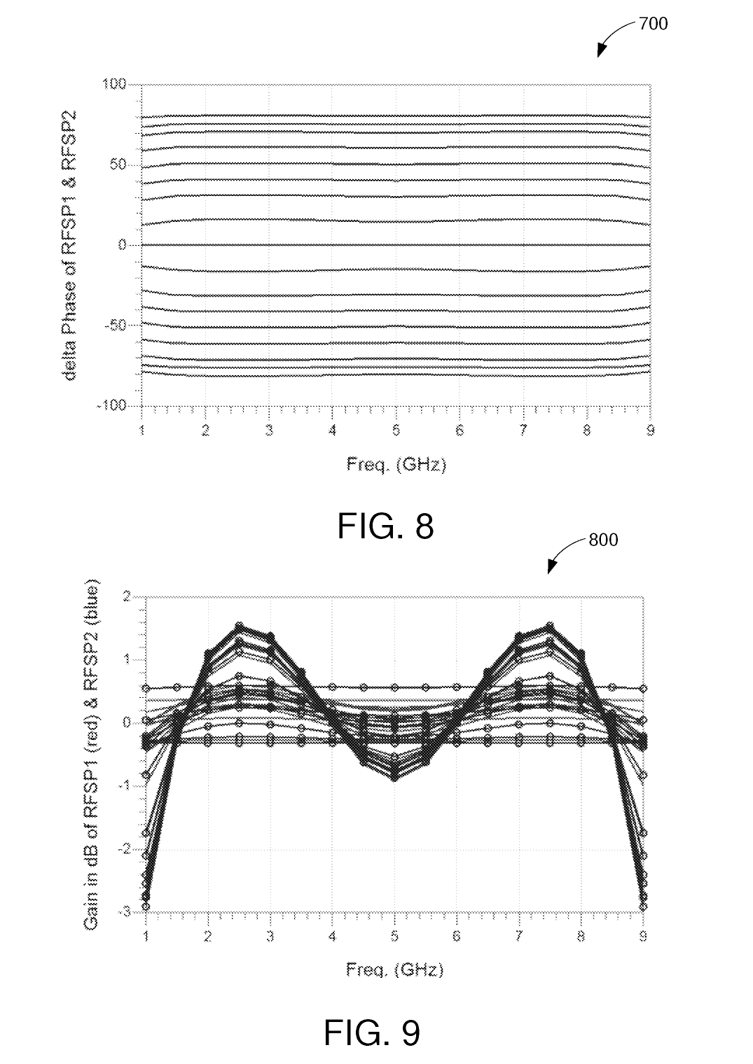

FIG. 10 shows a graph 900 showing the frequency response of RFSPs. In some examples, the frequency response may be dependent on one or more phase network settings. Some example phase network settings may include a physical length of transmission lines in the phase networks. By using different physical lengths of 310 to 315 and 340 to 345 (e.g., in FIG. 3A), different frequency range coverage of RFSP can be achieved. For example, one section of delay line's electrical phase may be equal to 90 degree at 6 GHz for the 909 trace, at 10GHz for the 911 trace, at 15 GHz for the 913 trace and at 20GHz for the 915 trace. Such property gives flexibility on the product implementation, allowing the same active circuits being used for realizing RFSP to cover different bandwidth.

FIG. 11A shows a circuit diagram of an example PIU 1000. For example, the circuit diagram of FIG. 11A may be used to implement any of the PIUs of FIG. 3A, however other circuits may be used to implement some or all of the features of the PIU 1000. Any of the PIUs described herein can be implemented as an active balun. For example, an input 1010 of the PIU 1000 can balanced and the output of the PIU 1000 can be single ended (unbalanced). Output 1020 may be an inverting output while output 1030 can be a non-inverting output.

FIG. 11B shows a circuit of an example GCU 1100. In some examples, the gain provided by the GCU 1100 may be controlled by changing a gate voltage of a transistor (shown as VGG in FIG. 11B). The example GCU 1100 shows a common drain field effect transistor (FET) driving a common source FET. However, other GCU implementations may be used.

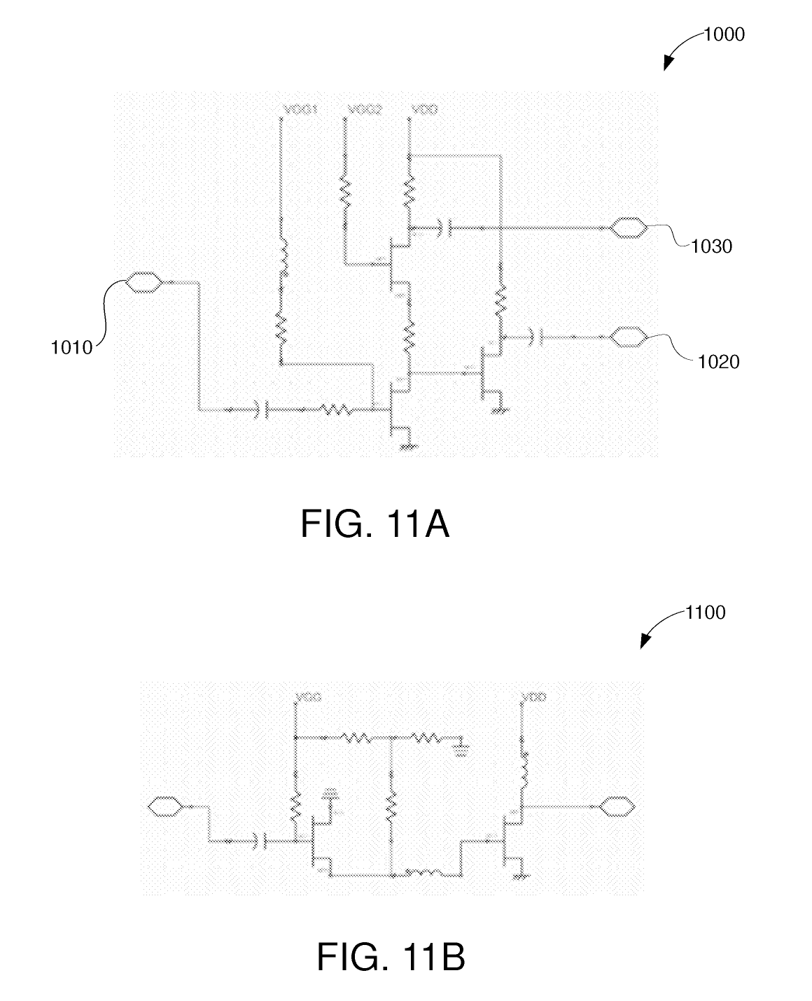

FIG. 12 shows example responses of GCUs included in a five tap RFSP, where the GCUs are implemented using a gallium arsenide (GaAs) pseudomorphic high electron mobility transistor (pHEMT) process. For example, graph 1200 shows a frequency/gain relationship for various GCUs. Graph 1210 shows a gate voltage vs gain relationship for various GCUs.

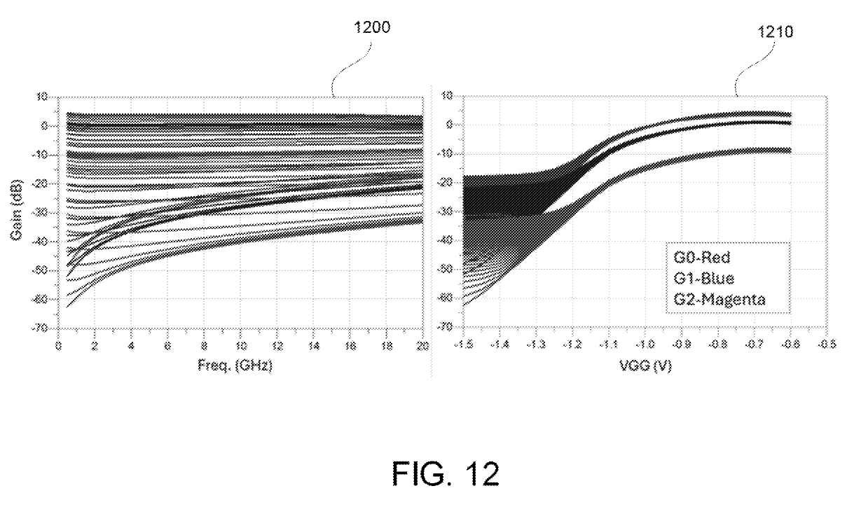

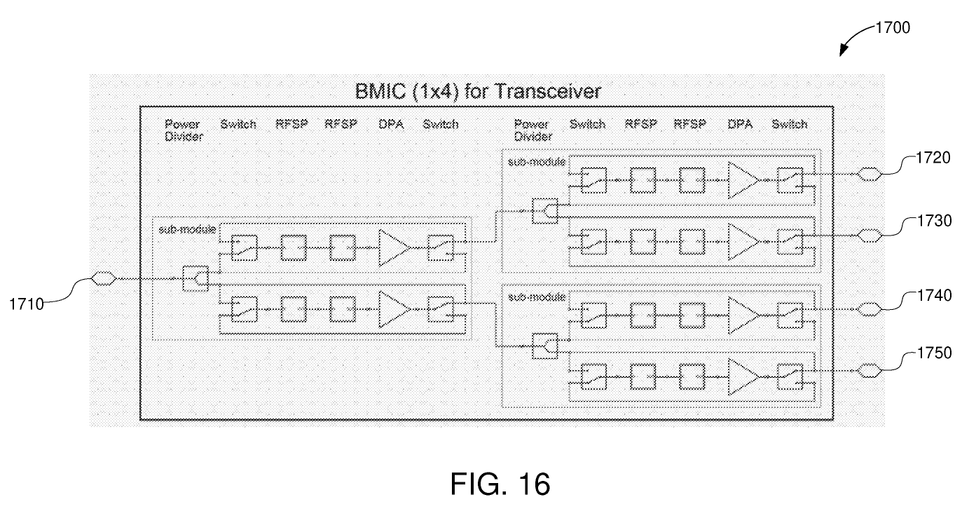

FIGS. 13, 14, 15 and 16 illustrate the use of one or more RFSP units described herein as part of a modular approach that may include implementing RFSP-based BMICs. In these examples, the box labeled 'sub-module' is a key building block and can be implemented as a single chip or a single package. The BMIC may be implemented through using either a multi-chip module or packages in package. In FIGS. 13-16, any of the blocks labeled as RFSP may include one or more multiple RFSPs in cascade to achieve wider phase range tuning. One RFSP is only able to achieve < +/-90 degree phase tuning as shown in FIG. 8. For example, FIG. 16 schematically illustrates how to cascade one or more RFSP and a distributed power amplifier (DPA) to achieve the BMIC which allows achieve +/-60 beam steering in an active phased array.

FIG. 13 shows an example implementation of a BMIC 1400 configured for transmitting RF signals. The example BMIC 1400 can include six RFSPs that are connected together through a number of power dividers. In some examples, the BMIC 1400 may be realized with sub-modules. For example, each sub-module may include a power divider and two RFSPs. In the example BMIC 1400, a RF signal can be received at input port 1410. The RFSPs included in the BMIC 1400 can apply phase delays to the RF signal and output four RF signal on the output ports 1420, 1430, 1440, and 1450. Each output port may be configured to provide differing amounts of phase delay thereby enabling a beam-steered (beam-formed) RF signal to be output from output ports 1420, 1430, 1440, and 1450. In some examples, each output port 1420, 1430, 1440, and 1450 may be coupled to an independent antenna (not shown).

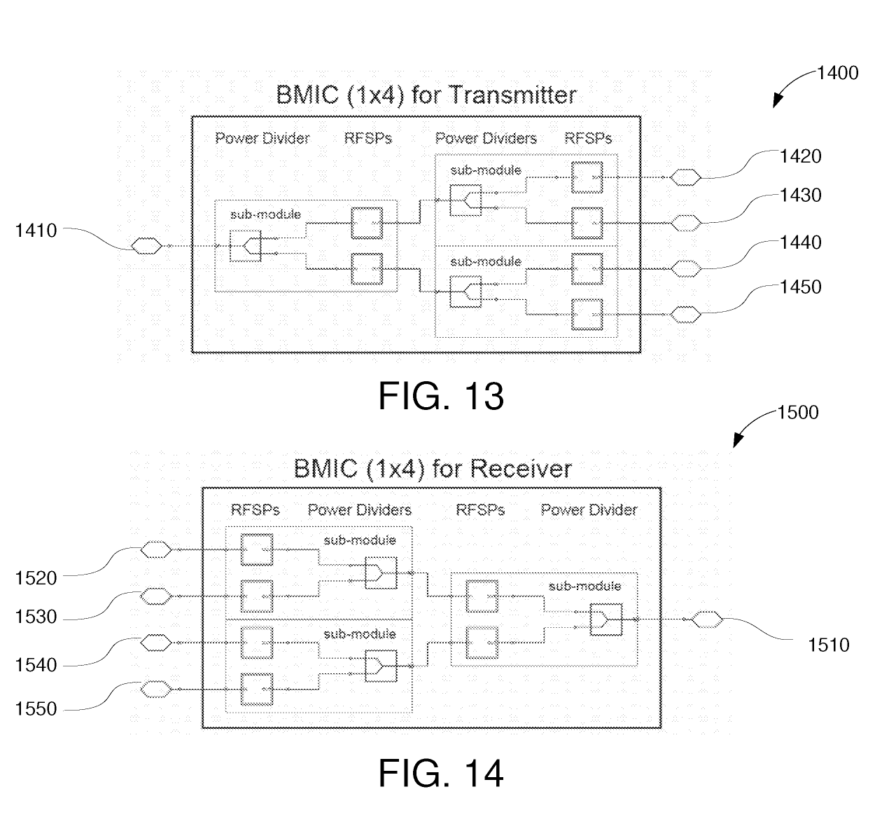

FIG. 14 shows an example implementation of a BMIC 1500 configured for receiving RF signals. Similar to the BMIC 1400 of FIG. 13, The example BMIC 1500 can include six RFSPs that are connected together through a number of power dividers. In some examples, the BMIC 1500 may be realized with sub-modules. For example, each sub-module may include a power divider and two RFSPs. In the example BMIC 1500, four RF signals can be received at input ports 1520, 1530, 1540, and 1550. The RFSPs included in the BMIC 1300 can apply phase delays to the received RF signals and output a single RF signal on the output port 1510. Each input port may be configured to provide differing amounts of phase delay thereby enabling a beam-steered (beam-formed) RF signal to be received from inputs ports 1520, 1530, 1540, and 1550. In some examples, each input port 1520, 1530, 1540, and 1550 may be coupled to a separate antennas (not shown).

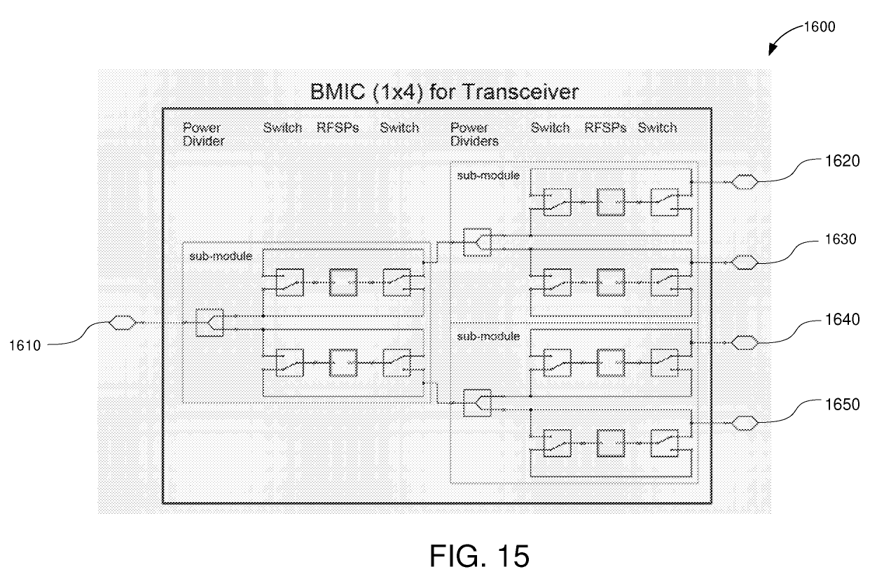

FIG. 15 shows an example implementation of a BMIC 1600 that can perform operations of a transceiver. That is, the BMIC 1600 can transmit or receive beam-formed RF signals. Similar to the BMIC 1300 of FIG. 13 and the BMIC 1500 of FIG. 15, the BMIC 1600 can include three sub-modules. In this example, each sub-module can be bidirectional and include two RFSPs, a power divider, and four RF switches that enable RF signals to be split and phase-delayed, or phase-delayed and combined. The BMIC 1600 can include I/O port 1610 that can receive an RF signal that is meant to be split and beam-steered, or output an RF signal that has been received and combined by the BMIC 1600. Antenna ports 1620, 1630, 1640, and 1650 may be coupled to separate antennas (not shown).

FIG. 16 shows another example BMIC 1700 that can perform operations of a transceiver. The BMIC 1700 can include three bidirectional sub-modules. Each sub-module can include a wideband amplifier disposed after the cascaded RFSPs. The BMIC 1700 can include I/O port 1710 that can receive an RF signal that is meant to be split and beam-steered, or output an RF signal that has been received and combined by the BMIC 1700. Antenna ports 1720, 1730, 1740, and 1750 may be coupled to separate antennas (not shown).

In some examples, beam steering of +/- sixty degrees of an active phased array may be obtained with a minimum +/- 150 degree phase difference between adjacent antenna elements is needed. To achieve such phase range, cascading two RFSPs may be used for each channel. And to better match with system power budget requirement and compensate for insertion loss of cascaded RFSPs attributed to the selected semiconductor process characteristics, a wideband distributed amplifier can be added after the RFSPs in each sub-module.

### Manufacturing

As mentioned above, also described herein are methods of manufacturing an RFSP-based apparatus (e.g., an apparatus including one or more RFSP). For example, an RFSP can be implemented as part of a monolithic microwave integrated circuits (MMICs), e.g., in PCB-based packages; the MMIC may be manufactured with semiconductor processes as GaAs, RF-CMOS, GaNSi or any other processes where the electrical parameters fits the design requirements described herein. RFSP-containing apparatuses may also be implemented as a combination of IC with PCB based packages, where the transmission lines are implemented using multi-layer PCBs as part of the package.

For example, described herein are methods of manufacturing a radio-frequency signal processing (RFSP) device (such as any of the RFSP devices described herein). In some cases, these methods may include: forming an integrated circuit including an RFSP input port, an RFSP output port, a plurality of gain control units (GCUs) coupled in parallel between the input port and the output port, wherein inputs of the GCUs are coupled to the input port of the RFSP and outputs of the GCUs are coupled to the output port of the RFSP, wherein each GCU, a first plurality of time delay units, wherein each of the first plurality of the time delay units is configured to couple an input of one GCU of the plurality of GCUs to an input of another GCU of the plurality GCU, and a second plurality of time delay units, wherein each of the second plurality of time delay units is configured to couple an output one GCU of the plurality of GCUs to an output of another GCU of the plurality of GCUs, wherein a phase delay of the RF signal through the RFSP device is based on gain settings of the plurality of GCUs. In some cases forming the integrated circuit (IC) may comprise forming the IC as part of a monolithic microwave integrated circuit (MMIC). In any of these examples, forming the RFSP may include manufacturing the RFSP using a semiconductor processes such as (but not limited to) an GaAs, RF-CMOS, or GaNSi process.

Alternatively or additionally, the method may include forming the IC as part of as a combination of an IC with PCB based packages. The methods described herein may include forming the transmission lines, wherein the transmission lines are implemented using multi-layer PCBs.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

When a feature or element is herein referred to as being "on" another feature or element, it can be directly on the other feature or element or intervening features and/or elements may also be present. In contrast, when a feature or element is referred to as being "directly on" another feature or element, there are no intervening features or elements present. It will also be understood that, when a feature or element is referred to as being "connected", "attached" or "coupled" to another feature or element, it can be directly connected, attached or coupled to the other feature or element or intervening features or elements may be present. In contrast, when a feature or element is referred to as being "directly connected", "directly attached" or "directly coupled" to another feature or element, there are no intervening features or elements present. Although described or shown with respect to one embodiment, the features and elements so described or shown can apply to other embodiments. It will also be appreciated by those of skill in the art that references to a structure or feature that is disposed "adjacent" another feature may have portions that overlap or underlie the adjacent feature.

Terminology used herein is for the purpose of describing particular embodiments only and is not intended to be limiting of the invention. For example, as used herein, the singular forms "a", "an" and "the" are intended to include the plural forms as well, unless the context clearly indicates otherwise. It will be further understood that the terms "comprises" and/or "comprising," when used in this specification, specify the presence of stated features, steps, operations, elements, and/or components, but do not preclude the presence or addition of one or more other features, steps, operations, elements, components, and/or groups thereof. As used herein, the term "and/or" includes any and all combinations of one or more of the associated listed items and may be abbreviated as "/".

Spatially relative terms, such as "under", "below", "lower", "over", "upper" and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as "under" or "beneath" other elements or features would then be oriented "over" the other elements or features. Thus, the exemplary term "under" can encompass both an orientation of over and under. The device may be otherwise oriented (rotated 90 degrees or at other orientations) and the spatially relative descriptors used herein interpreted accordingly. Similarly, the terms "upwardly", "downwardly", "vertical", "horizontal" and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word "about" or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/- 0.1% of the stated value (or range of values), +/- 1% of the stated value (or range of values), +/- 2% of the stated value (or range of values), +/- 5% of the stated value (or range of values), +/- 10% of the stated value (or range of values), etc. Any numerical values given herein should also be understood to include about or approximately that value, unless the context indicates otherwise. For example, if the value "10" is disclosed, then "about 10" is also disclosed. Any numerical range recited herein is intended to include all sub-ranges subsumed therein. It is also understood that when a value is disclosed that "less than or equal to" the value, "greater than or equal to the value" and possible ranges between values are also disclosed, as appropriately understood by the skilled artisan. For example, if the value "X" is disclosed the "less than or equal to X" as well as "greater than or equal to X" (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A radio-frequency signal processing (RFSP) device for providing a variable pre-determined phase delay to a radio-frequency (RF) signal, the RFSP device comprising:
an RFSP input port;
an RFSP output port;
a plurality of gain control units (GCUs), comprising an odd number of GCUs, coupled in parallel between the input port and the output port, wherein inputs of the GCUs are coupled to the input port of the RFSP and outputs of the GCUs are coupled to the output port of the RFSP, wherein each GCU;
a first plurality of time delay units, wherein each of the first plurality of the time delay units is configured to couple an input of one GCU of the plurality of GCUs to an input of another GCU of the plurality GCU; and
a second plurality of time delay units, wherein each of the second plurality of time delay units is configured to couple an output one GCU of the plurality of GCUs to an output of another GCU of the plurality of GCUs,
wherein a phase delay of the RF signal through the RFSP device is based on gain settings of the plurality of GCUs.

2. The RFSP device of claim 1, further comprising at least one phase inversion unit coupled between an input of one of the plurality of GCUs and the input port of the RFSP device and configured to invert the phase of an RF signal from the input port of the RFSP device to the input port of the GCU.

3. The RFSP device of claim 2, wherein the at least one phase inversion unit comprises (n-1)/2 phase inversion units, where n is the number of GCUs.

4. The RFSP device of claim 1, wherein each of the time delay units is a transmission line.

5. The RFSP device of claim 1, wherein each of the plurality of GCUs have an approximately equal propagation delay.

6. The RFSP device of claim 1, wherein the gain settings of the plurality of GCUs symmetric with respect to a center GCU.

7. The RFSP device of claim 1, wherein the RFSP device comprises an integrated chip including the plurality of CGUs.

8. A radio-frequency (RF) beamforming apparatus, comprising:
an input port configured to receive an input RF signal;
a first output port;
a second output port;
first radio-frequency signal processing (RFSP) device configured to output a first RF signal having a first phase delay based on gain settings of a first plurality of gain control units (GCUs) of the first RFSP device;
a second RFSP device configured to output a second RF signal having a second phase delay based on gain settings of a second plurality of GCUs of the second RFSP device; and
a power divider configured to split and couple the input RF signal to an input of the first RFSP device and an input of the second RFSP device,
wherein the first output port is configured to output the first RF signal and the second output port is configured to output the second RF signal and the first phase delay and the second phase delay are configured to beam steer the first RF signal and the second RF signal.

9. The RF beamforming apparatus of claim 8, wherein the first output port is coupled to a first antenna and the second output port is coupled to a second antenna.

10. The RF beamforming apparatus of claim 8, further comprising one or more amplifiers coupled to the first and/or second output ports.

11. The RF beamforming apparatus of claim 8, wherein the first RFSP device comprises at least one phase inversion unit coupled between an input of one of the first plurality of GCUs and the input port of the first RFSP device and configured to invert the phase of an RF signal from the input port of the first RFSP device to the input port of the GCU.

12. The RF beamforming apparatus of claim 8, wherein the first RFSP device comprises:
a first plurality of time delay units, each of the first plurality of the time delay units configured to couple an input of one of the first plurality of GCUs to an input of another of the first plurality GCUs; and
a second plurality of time delay units, wherein each of the second plurality of time delay units configured to couple an output one of the first plurality of GCUs to an output of another of the first plurality of GCUs.

13. The RF beamforming apparatus of claim 12, wherein each of the time delay units are transmission lines.

14. The RF beamforming apparatus of claim 8, wherein each of the first plurality of GCUs have an approximately equal propagation delay.

15. The RF beamforming apparatus of claim 8, further comprising:
a third RFSP device coupled in cascade after the first RFSP device and configured to receive the first RF output signal and output a third RF signal having a third phase delay based on gain settings of a third plurality of gain control units (GCUs) of the third RFSP device; and
a wide band amplifier configured to amplify the third RF signal from the third RFSP device.

16. A method of manufacturing a radio-frequency signal processing (RFSP) device, the method comprising:
forming an integrated circuit (IC) including an RFSP device, the RFSP device including: an input port, an RFSP output port, a plurality of gain control units (GCUs) coupled in parallel between the input port and the output port, wherein inputs of the GCUs are coupled to the input port of the RFSP and outputs of the GCUs are coupled to the output port of the RFSP, wherein each GCU, a first plurality of time delay units, wherein each of the first plurality of the time delay units is configured to couple an input of one GCU of the plurality of GCUs to an input of another GCU of the plurality GCU, and a second plurality of time delay units, wherein each of the second plurality of time delay units is configured to couple an output one GCU of the plurality of GCUs to an output of another GCU of the plurality of GCUs, wherein a phase delay of the RF signal through the RFSP device is based on gain settings of the plurality of GCUs.

17. The method of claim 16, wherein forming the integrated circuit comprising forming the RFSP as a monolithic microwave integrated circuit (MMIC).

18. The method of claim 16, wherein forming the integrated circuit comprises forming using a semiconductor processes selected from one or more of: an GaAs process, an RF-CMOS, and/or a GaNSi process.

19. The method of claim 16, wherein forming the integrated circuit comprises forming the RFSP as an IC with a multi-layer PCB.
